(19) United States
(12) Patent Application Publication
(10) Pub. No.: US 2018/0198306 A1
(43) Pub. Date: Jul. 12, 2018

(54) Induction Power Transfer Charger for Tablet to Tablet Wireless Charging

(71) Applicants: Robert Findley, South Jordan, UT (US); Matthew Hawkes, South Jordan, UT (US)

(72) Inventors: Robert Findley, South Jordan, UT (US); Matthew Hawkes, South Jordan, UT (US)

(21) Appl. No.: 15/400,896

(22) Filed: Jan. 6, 2017

(51) Int. Cl. H02J 7/02; H02J 7/00; H02J 50/12; G06F 1/32; G06F 1/26

(52) U.S. Cl. CPC H02J 7/025; H02J 7/0054; H02J 50/12; H02J 2007/0062; G06F 1/266; G06F 1/263; H02J 2007/0059; G06F 1/3287

(57) ABSTRACT

A wireless power transfer charger comprising one or more magnetic resonance units for equalizing stored power between two tablet data processing devices (DPDs) in close proximity to the wireless power transfer charger.

### FIELD OF THE INVENTION

This invention relates to recharging devices for microprocessors, and more particularly relates to wireless charging stations for cellular phones and tablet computers making use of inductive power transfer or magnetic resonance.

### BACKGROUND

### Description of the Related Art

The present invention relates to wireless chargers for microprocessing devices, including cellular phones and tablet computers. The proliferation of microprocessing devices has become so great that often insufficient numbers of chargers are available in residences or other fixed locations to keep the devices all charged. Even the chargers that do exist are often break, malfunction, or are lost. Cords forming part of traditional charges become tangled.

Although electrical wall receptacles are plentiful and positioned throughout buildings to be easily accessible, they are of antiquated vintage, of alternating current, and do not incorporate means to wirelessly charge modern microprocessing devices. Even receptacles with D/C wires for engaging micro-USB ports can become tangled and break.

Although wireless charging stations and pads are known in the art, there

The inconvenience or the difficulty encountered by users of portable microprocessing devices could be substantially alleviated if an efficient charging station, compatible with electrical A/C receptacles for supplying electrical D/C power were available. There is a substantial need for a means to effectively position a source of electrical power which for recharging these devices.

### SUMMARY

From the foregoing discussion, it should be apparent that a need exists for a wireless charger with tablet DPD to tablet DPD functionality. Beneficially, such a device would overcome inefficiencies with the prior art by providing a wireless charger for tablet DPD to tablet DPD equalization.

The present invention has been developed in response to the present state of the art, and in particular, in response to the problems and needs in the art that have not yet been fully solved by currently available apparti. Accordingly, the present invention has been developed to provide a wireless power transfer charger for tablet DPD to tablet DPD charging, the charger comprising: a polymeric housing having a planar top surface and a planar bottom surface; an AC to high frequency AC converter disposed within the housing; a PCBA; a first magnetic resonance unit disposed above a second magnetic resonance unit, the first magnetic resonance unit comprising: a transmitter coil, and a transmitter circuit; a second magnetic resonance unit disposed below the first magnetic resonance unit, the second magnetic resonance unit comprising: a receiver coil, and a receiver circuit; wherein the charger is adapted to equalize a stored electrical charge between two tablet DPDs by drawing power from a tablet DPD using magnetic induction, storing this power in a battery, and transmitting the power to a tablet DPD using magnetic induction.

The charger may further comprise a switch adapted to flow alternating electrical current from a power outlet through the first magnetic resonance unit in response to inclusion of a converter in an electrical circuit. The top surface may cover less area than the bottom surface.

A second wireless power transfer charger for tablet DPD to tablet DPD charging is provided, the charger comprising: a polymeric housing; a PCBA; a first magnetic resonance unit disposed above a second magnetic resonance unit, the first magnetic resonance unit comprising: a transmitter coil, and a transmitter circuit; a second magnetic resonance unit disposed below the first magnetic resonance unit, the second magnetic resonance unit comprising: a receiver coil, and a receiver circuit; wherein the charger is adapted to equalize a stored electrical charge between two tablet DPDs by drawing power from a tablet DPD using magnetic induction, storing this power in a battery, and transmitting the power to a tablet DPD using magnetic induction.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of an induction power transfer charger for tablet to tablet wireless charging in accordance with the present invention;

FIG. 2 is a side perspective view of an induction power transfer charger for tablet to tablet wireless charging in accordance with the present invention;

FIG. 3 is a side perspective view of an induction power transfer charger for tablet to tablet wireless charging in accordance with the present invention;

FIG. 4 is a top perspective view of an induction power transfer charger for tablet to tablet wireless charging in accordance with the present invention;

FIG. 5 is a bottom perspective view of an induction power transfer charger for tablet to tablet wireless charging in accordance with the present invention;

FIG. 6 is a forward perspective view of an induction power transfer charger for tablet to tablet wireless charging in accordance with the present invention;

FIG. 7 is a side perspective view of an induction power transfer charger for tablet to tablet wireless charging in accordance with the present invention;

FIG. 8 is a rear perspective view of an induction power transfer charger for tablet to tablet wireless charging in accordance with the present invention; and

FIG. 9 is a schematic of a one embodiment of a magnetic resonance unit for inducting power transfer for tablet to tablet wireless charging in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

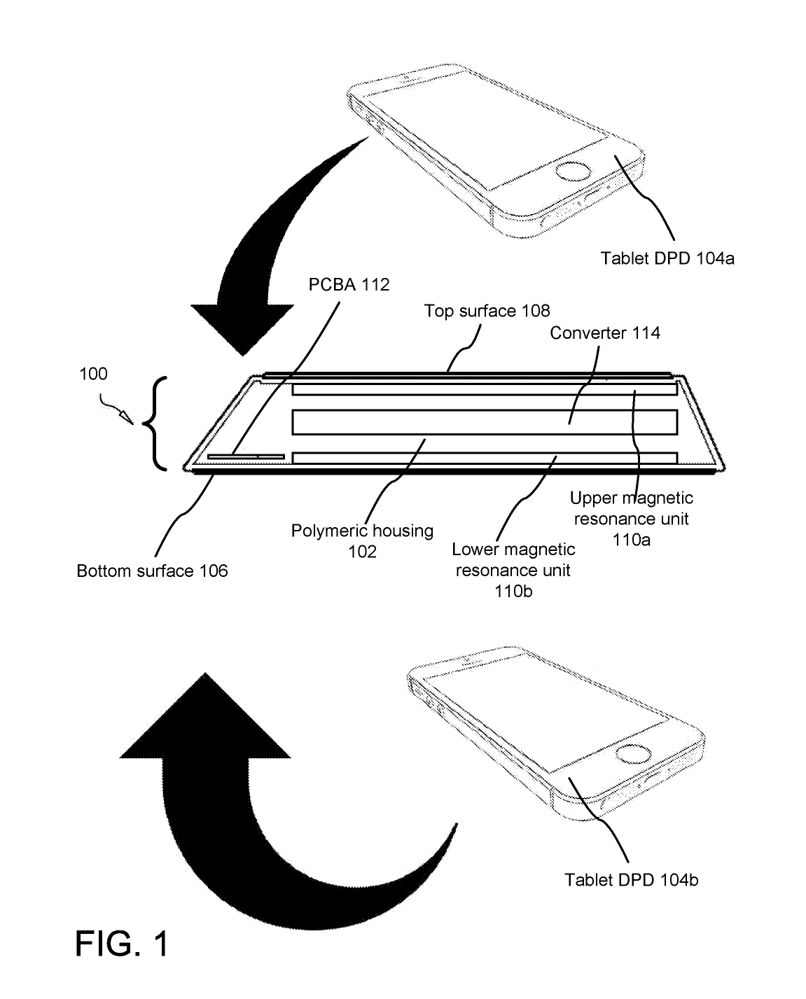

FIG. 1 is a side perspective view of an induction power transfer charger for tablet to tablet wireless charging in accordance with the present invention.

The portable charger 100 includes a housing 102. The housing 102 may define a plurality of slots for housing USB ports. In some embodiments, the device 100 comprises USB plugs or other digital plugs known to those of skill in the art.

The housing 102 includes one or more AC to DC converters, or AC to high frequency AC converters in the preferred embodiment. Converters are well-known and commercially available. The device 100 may be adapted for charging a single device using current inflow from a standard 110 volt residential electrical system, or may be configured to draw power from a tablet DPD 104b and transfer it wireless to a tablet DPD 104a.

The housing 102 may be fabricated from any polymeric, metal alloy, or organic material, including nylon, aluminum and leather. In various embodiments, the housing 102 forms a cubic shape, square or rectangular from a forward perspective view, while in still other embodiments, the housing is oblong or

The housing 102 has a planar top surface 108 and a planar bottom surface 106. In the shown embodiment, the planar bottom surface 106 is larger than the planar top surface 108. The housing 102 tapers as the housing 102 rises.

An AC plug, including two or three prongs, may be affixed to the housing 102. In various embodiments, the charging unit 100 may consist of two or more AC plugs. Electrical contact with the magnetic power units 110a-b may be made through an AC to DC converter and a connecting when AC power in being input into the power supply 112. In the preferred embodiment, the converter 114 converts AC to high frequency AC for transmission by a transmitter circuit within the housing 102 to transmitter coil internal or external to a tablet DPD 104. The converter 114 (or inverter) may convert the AC voltage transmitted from the electrical receptacle to high frequency AC voltage or direct current at a voltage and current appropriate for recharging a tablet DPD 104.

The polymeric housing 102 includes wireless power transfer functionality for inductive charging of tablet DPDs 104. In various embodiments, the device 100 comprises a magnetic resonance (or inductive power transfer) unit 110 for charging a tablet DPD 104a sitting above the device 100.

In various other embodiments, the device 100 comprises a plurality of magnetic resonance (or inductive power transfer) units 110a-b, with unit 110a for charging a tablet DPD 104a by drawing power using the lower magnetic resonance unit 110b from the tablet DPD 104b.

A transmitter circuit within a unit 110a sends the high frequency alternating current to a transmitter coil, which induces a time-varying magnetic field in the transmitter coil. The magnetic field generates current within the receiver coil of the receiving device (tablet DPD 104a). Energy is transmitted between the transmitter in unit 110a and receiver coil in tablet DPD 104a using resonant (or magnetic) coupling and is achieved by the transmitter coil and the receiver coil resonating at the same frequency. Current flowing within the receiver coil is converted into direct current by the receiver circuit, which uses the current to charge the battery.

Electrical current within the device 100 may originate with the power supply 112 or a tablet DPD 104b. In various embodiments, the charger 100 comprises a PCBA 112 for managing power input from lower magnetic resonance unit 110b to a battery.

The stored charge in the battery is output to the upper magnetic resonance unit 110a by a PCBA 112 regulating inflow and outflow to the battery. Current from the battery flows through a transmitter coil within the upper magnetic unit 110a and induced direct current within the tablet DPD 104a.

The device 100 may also comprise a power supply 112, which is well-known to those of skill in the art, and is adapted in the present invention to manage the transfer of power in and out of the device 100.

The PCBA 112 mechanically supports and electrically connects electronic components of the device 100 and is well-known to those of skill in the art.

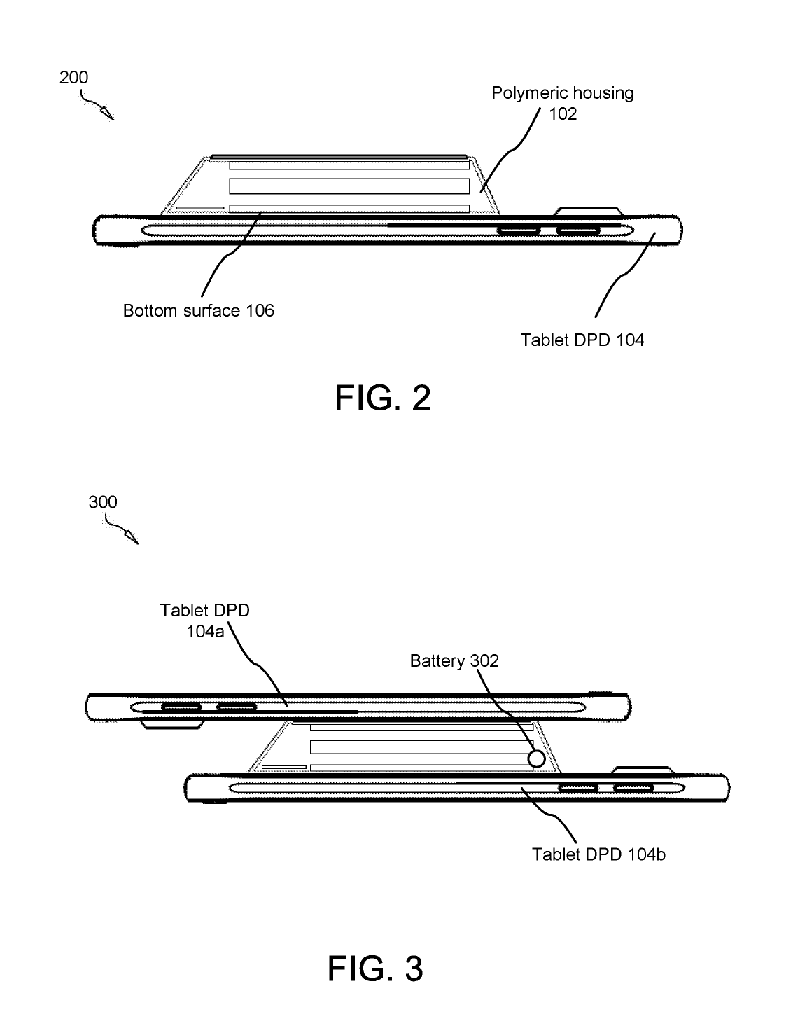

FIG. 2 is a side perspective view of an induction power transfer charger 200 for tablet to tablet wireless charging in accordance with the present invention.

In the shown embodiment, the bottom surface 106 of the polymeric housing 102 rests upon a tablet DPD 104 with a transmitter coil within the housing 102 in close proximity to a receiver coil within the tablet DPD 104. In other embodiments, a coil within the tablet DPD 104 acts as the transmitter coil and the coil within the housing 102 acts as the receiver coil for the purpose of drawing power from the tablet DPD 104.

FIG. 3 is a side perspective view of an induction power transfer charger 300 for tablet to tablet wireless charging in accordance with the present invention.

In various embodiments of the present invention, the charger 300 comprises a single coil disposed within the housing 102. This coil acts as the receiver coil to one of two tablet DPDs with higher stored power and as the transmitter coil to the tablet DPD with lower stored power, effectively inducing a charge between the two tablet DPDs 104 such that the tablet DPD 104 with lower stored power is brought into equilibrium with the tablet DPD 104 having higher stored power. It is an object of the present invention to provide a means for equalizing charges between to tablet DPDs 104 with wireless charging protocols.

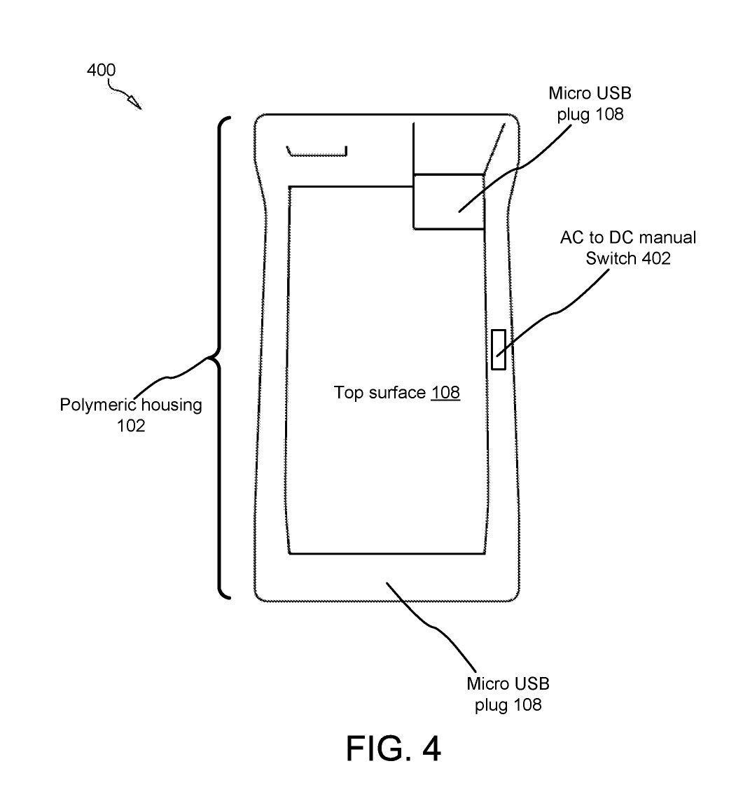

FIG. 4 is a top perspective view of an induction power transfer charger 400 for tablet to tablet wireless charging in accordance with the present invention.

The bottom surface 106 covers a smaller area than the top surface 108.

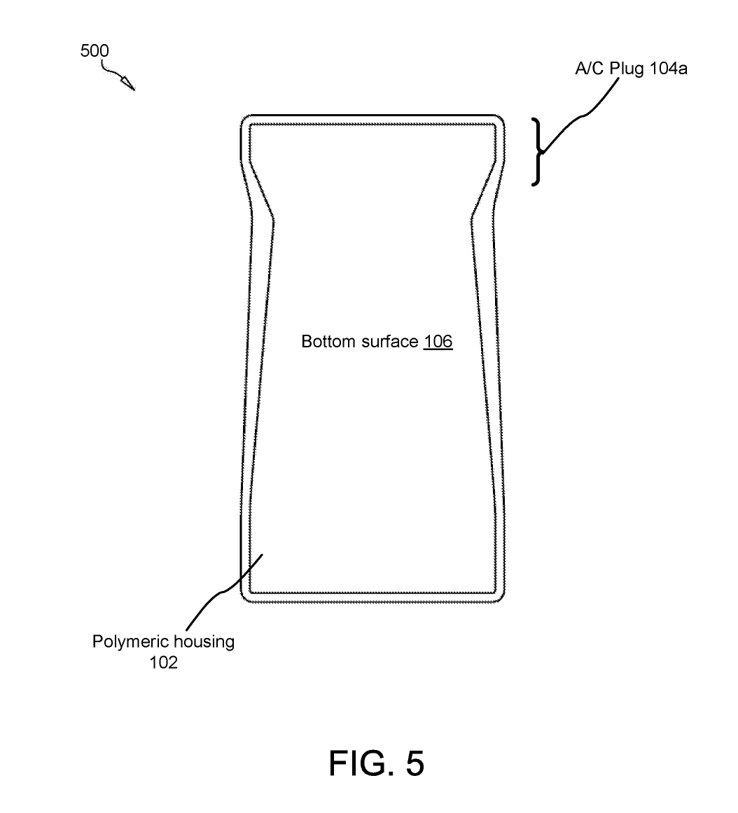

FIG. 5 is a bottom perspective view of an induction power transfer charger for tablet to tablet wireless charging in accordance with the present invention.

As shown.

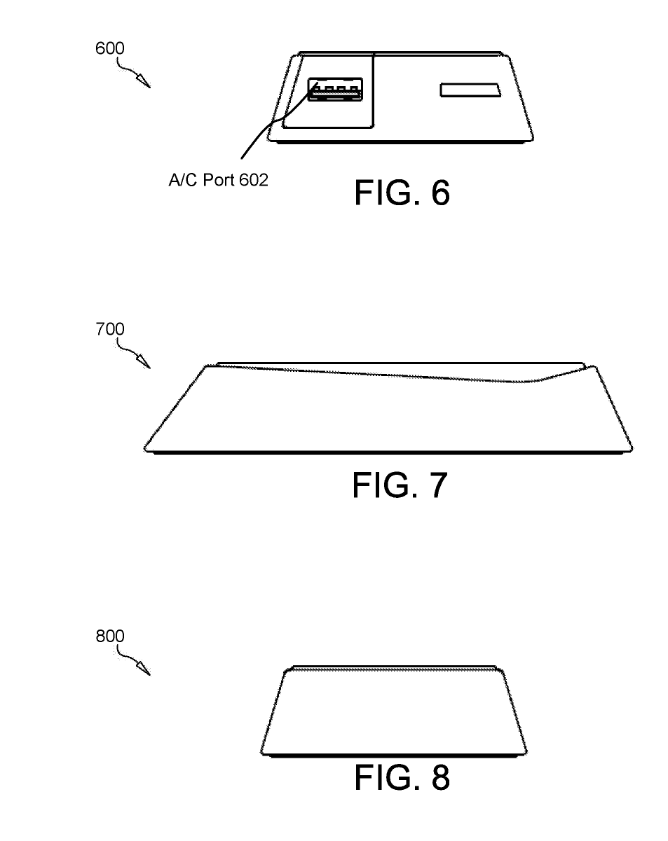

FIG. 6 is a forward perspective view of an induction power transfer charger for tablet to tablet wireless charging in accordance with the present invention.

The charger 600 comprises an AC port 602 for receiving an alternating current electrical chord.

FIG. 7 is a side perspective view of an induction power transfer charger for tablet to tablet wireless charging in accordance with the present invention.

As shown.

FIG. 8 is a rear perspective view of an induction power transfer charger for tablet to tablet wireless charging in accordance with the present invention.

As shown.

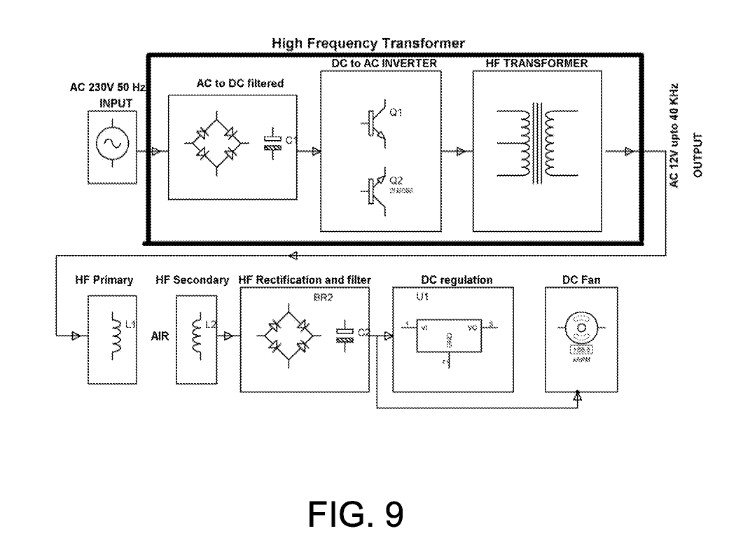

FIG. 9 is a schematic of a one embodiment of a magnetic resonance unit for inducting power transfer for tablet to tablet wireless charging in accordance with the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wireless power transfer charger for tablet DPD to tablet DPD charging, the charger comprising:
a polymeric housing having a planar top surface and a planar bottom surface;
an AC to high frequency AC converter disposed within the housing;
a PCBA;
a first magnetic resonance unit disposed above a second magnetic resonance unit, the first magnetic resonance unit comprising:
a transmitter coil, and
a transmitter circuit;
a second magnetic resonance unit disposed below the first magnetic resonance unit, the second magnetic resonance unit comprising:
a receiver coil, and
a receiver circuit;
wherein the charger is adapted to equalize a stored electrical charge between two tablet DPDs by drawing power from a tablet DPD using magnetic induction, storing this power in a battery, and transmitting the power to a tablet DPD using magnetic induction.

2. The charger of claim 1, further comprising a switch adapted to flow alternating electrical current from a power outlet through the first magnetic resonance unit in response to inclusion of a converter in an electrical circuit.

3. The charger of claim 1, wherein the top surface covers less area than the bottom surface.

4. A wireless power transfer charger for tablet DPD to tablet DPD charging, the charger comprising:
a polymeric housing;
a PCBA;
a first magnetic resonance unit disposed above a second magnetic resonance unit, the first magnetic resonance unit comprising:
a transmitter coil, and
a transmitter circuit;
a second magnetic resonance unit disposed below the first magnetic resonance unit, the second magnetic resonance unit comprising:
a receiver coil, and
a receiver circuit;
wherein the charger is adapted to equalize a stored electrical charge between two tablet DPDs by drawing power from a tablet DPD using magnetic induction, storing this power in a battery, and transmitting the power to a tablet DPD using magnetic induction.
